(19) United States
(12) Patent Application Publication
(10) Pub. No.: US 2026/0127483 A1
(43) Pub. Date: May 7, 2026

(54) COMPUTER-IMPLEMENTED METHOD FOR TRAINING OF A MACHINE LEARNING MODEL IN FALL ASSESSMENT

(71) Applicant: Autoliv Development AB, Vargarda (SE)

(72) Inventor: Jawwad AHMED, Vargarda (SE)

(21) Appl. No.: 18/704,318

(22) PCT Filed: Oct. 28, 2022
(86) PCT No.: PCT/EP2022/080160

§ 371 Date: Apr. 24, 2024

(30) Foreign Application Priority Data
Oct. 29, 2021 (SE) 2151327-0

(51) Int. Cl. G06N 20/00

(52) U.S. Cl. CPC G06N 20/00

(57) ABSTRACT

A computer-implemented method for training of a machine learning model in fall assessment comprising fall detection, for a fall assessment training environment; comprising implementing the machine learning model, and preparing training data. Preparing training data comprises: obtaining and automatically annotating sensor data from sensors, collecting data from subjects, and coupling values of each subject to their sensor data, respectively, Using the sensor data for generating a time series that comprises data points. Automatically annotating the data points such that each data point is annotated reflecting the corresponding sensor data, respectively. Using the data points, dynamically segmenting said time series into at least event segments associated with fall events and event segments that are not associated with fall events. Using the event segments to construct time windows along the time series such that the time series is discretized, each time window comprising a plurality of time steps.

### DESCRIPTION OF THE DISCLOSURE

The present disclosure relates to an improved computer-implemented method for training of a machine learning model in fall assessment, a computer program comprising computer readable instructions for applying the computer-implemented method and/or preparation of training data, a computer program comprising computer readable instructions for a machine learning model, computer readable mediums comprising the computer programs, as well as, a control unit arrangement, a device, and a system, for training of a machine learning model. Further, the present disclosure also relates to a computer-implemented method for fall assessment, and computer programs, computer readable mediums, control unit arrangements, devices, and systems, therefore.

Falls are one leading cause of human injury and injury-related deaths. Fall detections and fall predictions are together with machine learning approaches of increased usefulness. Machine learning approaches are, for example, used today to distinguish fall and non-fall activities. At a high level, these approaches may include approaches involving vision-based arrangements which in real-time can classify falls based on live feed video. Vision-based arrangements may, in some instances, be less practical, e.g. in an outside environment, and may also come with potentially privacy issues. Further, there is also machine learning approaches focusing on more pervasive solutions being based on wearable device sensors which are non-intrusive and pervasive. In this area, see for example “A Cascade-Classifier Approach for fall detection, putra et al, MOBIHEALTH 2015, Oct. 14-16, London, Great Britain, January 2015, DOI: 10.4108/eai.14-10-2015.2261619” that proposes a cascade-classifier approach for this. Other examples include the M. Musci, D. D. Martini, N. Blago, T. Facchinetti, and M. Piastra, “Fall Detection using Recurrent Neural Networks,” p. 7 as well was the F. J. González-Cañete and E. Casilari, “A Feasibility Study of the Use of Smartwatches in Wearable Fall Detection Systems,” Sensors, vol. 21, no. 6, p. 2254, Mar. 2021, doi: 10.3390/s21062254.

However, there is still room for improvements in this area. In particular, regarding the requirements on availability of suitably annotated data that is used by fall detection-based algorithms for learning of various fall and non-fall scenarios. However, creating annotated training data for data-driven machine learning algorithms, i.e. for data-driven machine learning computer programs, is not a trivial task and usually requires manual effort of careful analysis and manual effort which can be time consuming and costly particularly in real-time settings where new data are always streaming in.

The falls may for example occur for a person walking in a home environment, or outside the home. In this context, falls also comprise falls occurring when riding a bicycle, scooter, motorcycle and the like, for example due to skidding, slipping, losing control of vehicle, crashing with another vehicle or object etc. Falls related to a running vehicle are often more abrupt, and require a faster handling than a fall occurring for a walking person that for example trips or slips.

This is achieved by means of a computer-implemented method for training of a machine learning model in fall assessment comprising fall detection, for a fall assessment training environment. The method comprises implementing the machine learning model, and preparing training data. Preparing training data comprises obtaining, and automatically annotating sensor data generated from sensors collecting data from the subjects, and coupling values of each subject to their specifically obtained, and annotated, sensor data, respectively, and using the sensor data for generating a time series that comprises data points.

Preparing training data further comprises automatically annotating the data points such that each data point is annotated reflecting the corresponding sensor data, respectively, and using the annotated data points, dynamically segmenting said time series into at least event segments associated with fall events and event segments that are not associated with fall events.

Preparing training data also comprises using the event segments to construct time windows along the time series such that the time series is discretized, each time window comprising a plurality of time steps, and automatically annotating the constructed time windows, where the automatic annotation of the time windows comprises information that identifies if the data points associated with the time steps in each window belong to a fall event or to a non-fall event.

This allows more accurate automatic identification of fall segments in a fall session using available information from the fallers/subjects and/or type of falls. This leads to more accurate annotation quality of time windows since the quality of the time window annotation is dependent on the quality of Segmentation annotation.

According to some aspects, the automatic annotation of the time windows comprises information that identifies the position of the time-steps belonging to the fall segment in each time window, and information regarding an assigned weight to each time window, where the assigned weight has been determined in dependence of said position.

These weights improve the quality of the machine-learned model, constituting a way to inform the training algorithm that it is more important to detect a fall as soon as it starts.

According to some aspects, the computer-implemented method further comprises communicating information comprising the prepared training data to the machine learning model, and training the machine learning model using the training data comprising the prepared training data in fall assessment.

According to some aspects, the obtained, and annotated, sensor data comprise sensor data generated during doings of the trainer subjects, said doings comprising activities daily living (ADLs), including real fall events, and/or simulated falls.

This means that the sensor data can be generated in a controlled environment, during controlled circumstances. Uncontrolled environments are also conceivable. Simulated fall and physical activity data may come from virtual software based simulations.

According to some aspects, the preparation of the training data comprises the obtaining, and the automatic annotation of the sensor data, wherein the sensor data are suitably obtained from sensors. The sensor data are typically obtained from sensors comprising, for example, motion sensors, 3D sensors, accelerometers, gyroscopes and/or cameras, e.g. motion sensors, 3D sensors, accelerometers and/or gyroscopes. The sensors may, for example, be wearable sensors, e.g. comprising motion sensors, 3D sensors, accelerometers and/or gyroscopes. The sensor data may be obtained from sensors, for example, wearable sensors, e.g. comprising motion sensors, 3D sensors, accelerometers and/or gyroscopes.

This means than many types of sensors can be used.

Wearable device comprises 3D sensors being accelerometres may be used to measure acceleration in 3 dimensions, and wearable device comprises 3D sensors being gyroscope may be used to measure rotational speed in 3 dimensions, from a person/a subject, i.e. trainer object/user, both in accordance with present disclosure, wearing such a wearable device. The wearable devices may suitably also be edge devices. According to some aspects, the sensors comprise at least one of motion sensors, 3D sensors, accelerometers, gyroscopes and/or cameras.

According to some aspects, the preparation of the training data comprises coupling values of each trainer subject to their specifically obtained, and annotated, sensor data.

During experiments, i.e. during said doings, with the wearable devices e.g. being 3d sensors, which suitably also are edge devices, data are generated by these 3d sensors at a specific frequency usually ranging from 25 HZ-200 HZ in the form of a multivariate time series which can be obtained, i.e. collected and buffered at the edge device before moving to an offline storage or uploaded to a Cloud device for further processing.

The obtained collected data is annotated, with respect to the start and end of an event of interest, i.e. an event, such as a fall, to define a segment for a collected experiment, i.e. for obtained data from said doings of the trainer subjects. That is dynamic segmentation is used to define the segment for the obtained data from said doings of the trainer subjects, and hereby suitably segments having “universal” length parameter, e.g. having default length, are defined. Once the data are collected, i.e. obtained, from experiments, the data need to be pre-processed which involves various stages including data quality checks, cleaning, scaling of data (normalization).

According to some aspects, the preparation of training data further comprises setting fall threshold values for sensor data and assignment of fall event segments if relevant sensor data are more than said fall threshold values.

This will in practice allow more suitable annotation for time windows, and/or for data samples, so as to ease the learning process of fall detection computer program, i.e. the training of the machine learning model in fall assessment, as described herein, to achieve a better fall detection performance.

According to some aspects, the preparation of training data further comprises utilization of a majority voting scheme for determining said corresponding sensor data to each annotated data point and for determining said dynamic segmentations into event segments.

According to some aspects, profile properties of the trainer subject profiles comprise profile properties, such as, height, weight and/or Body Mass Index (BMI), and wherein the values of the profile properties enable correlation of trainer subject profiles to corresponding user profiles, and more precise dynamic segmentation.

The values of these profile properties enable correlation of trainer subject profiles to corresponding user profiles. These profile properties may also influence this time-to-impact and hence allow more accurate definition of length of time segments for each subject/person and fall scenario.

The present disclosure also relates to a computer programs, control units, devices and systems that are associated with the above advantages.

Accordingly, it is here appreciated that the computer-implemented methods, the computer programs and the computer readable mediums, all as described herein, and in accordance with the present disclosure, may be realized in hardware, such as, the control unit arrangements and the devices, all as described herein, as well as, in the systems, as described herein. The hardware such as, the control unit arrangements and the devices, all as described herein, as well as, the systems, as described herein, are then arranged to perform the computer-implemented methods, and the computer programs, whereby the same advantages and effects are obtained as discussed for the computer-implemented methods herein.

Note that the terms “annotating”, “annotated”, and “annotation” may be used herein interchangeably.

### BRIEF DESCRIPTION OF DRAWINGS

The present disclosure will now be described more in detail with reference to the appended drawings, where:

FIG. 1 schematically illustrates a walking user wearing sensors;

FIG. 2 schematically illustrates a user who rides a motor bike and wear sensors;

FIG. 3 Schematically illustrates a schematic view over aspects of “the computer-implemented method for training of a machine learning model”, i.e. “Fall data Processing and Annotation System”, in accordance with the present disclosure;

FIG. 4 schematically illustrates a first step of dynamic segmentation;

FIG. 5 schematically illustrates a second step of dynamic segmentation;

FIG. 6 schematically illustrates a third step of dynamic segmentation;

FIG. 7 schematically illustrates a control unit;

FIG. 8 shows an example computer program product; and

FIG. 9 shows a flowchart for methods according to the present disclosure.

### DETAILED DESCRIPTION

Aspects of the present disclosure will now be described more fully hereinafter with reference to the accompanying drawings. The different arrangements, devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

With reference to FIG. 1, there is a user 1 wearing at least one sensor device 2, 3, here one wrist sensor device 2 and one waist sensor device 3. In this case, the user 1 is walking.

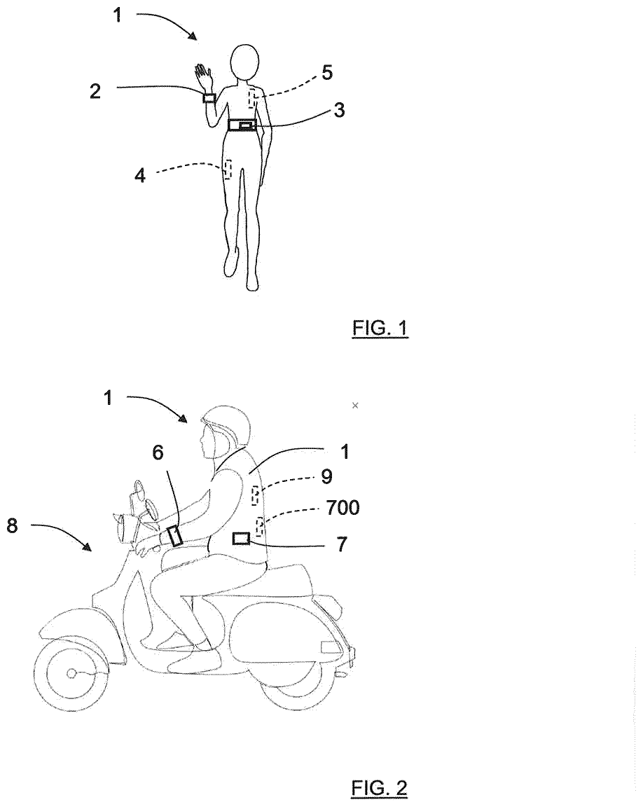

With reference to FIG. 2, there is a user 1 wearing at least one sensor device, here one wrist sensor device 6 and one vest sensor device 7 comprised in a protection garment such as a protection vest 10. In this case, the user 1 is riding a motor bike 8.

The present disclosure is applicable for users that are walking or travelling on, or in, any kind of vehicle such as a bike, a motor bike 8, a car etc.

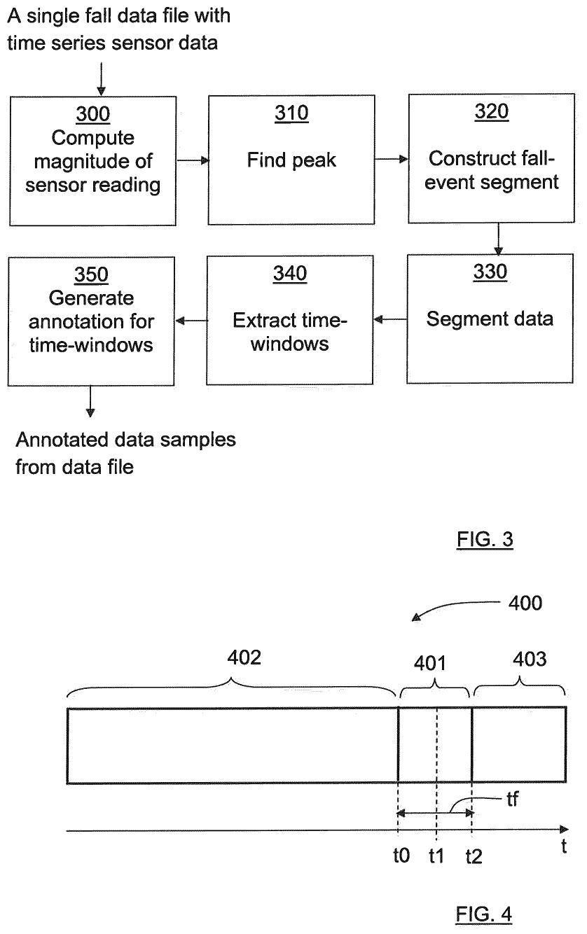

With reference to also to FIGS. 3-6, detailed aspects of “the computer-implemented method for training of a machine learning model”, “the implementation of the machine learning model” and “the preparation of training data”, i.e. “Fall data Processing and Annotation System” and “Key phases for Fall data Processing and Annotation System”, of the present disclosure are described. Sensor data are typically, but not exclusively, collected from, i.e. obtained from, sensors 2, 3, 6, 7, e.g. motion sensors, comprised in, e.g. mounted on, wearable devices, for example 3d sensors, such as accelerometers to measure the acceleration in 3 dimensions, as well as, gyroscope to measure the rotational speed in 3 dimensions from a person/a subject 1 i.e. trainer subject/s, and/or user 1, in accordance with the present disclosure, wearing such a wearable device 2, 3, 6, 7. The sensor data are obtained which is illustrated in FIG. 3 by “A single fall data file with time-series sensor data”.

During experiments and other ways to collect data, i.e. during doings of the trainer subjects in accordance with present disclosure, with the wearable devices e.g. being 3d sensors, which suitably also are edge devices, data are generated by these 3d sensors at a specific frequency usually ranging from 25 HZ-200 HZ in the form of a multivariate time series which can be obtained, i.e. collected and buffered at the edge device before moving to an offline storage or uploaded to a Cloud device for further processing.

The obtained data may comprise data obtained from other sources than sensors. The obtained data may refer to current, and past historical, data. This may include geographical positioning information of the user from GPS system as well as weather information.

According to some aspects, the user 1 wears means 11 for providing a position of the user 1 and communicating said position. Such means 11 can comprise any type of suitable positioning system, such as for example GPS or GNSS (Global Navigation Satellite Systems), and any type of wireless communication system. Said means can be comprised in a vest 11 or any suitable type of garment or wearable device.

Note that many times this collected data are not annotated (stating the start and end of an event of interest such as a fall to define a segment for a collected experiment, i.e. segmentation). Even though this segmentation can be done later offline in a data processing/cleaning stage, this typically requires a lot of manual effort (M. Musci, D. D. Martini, N. Blago, T. Facchinetti, and M. Piastra, “Fall Detection using Recurrent Neural Networks,”).

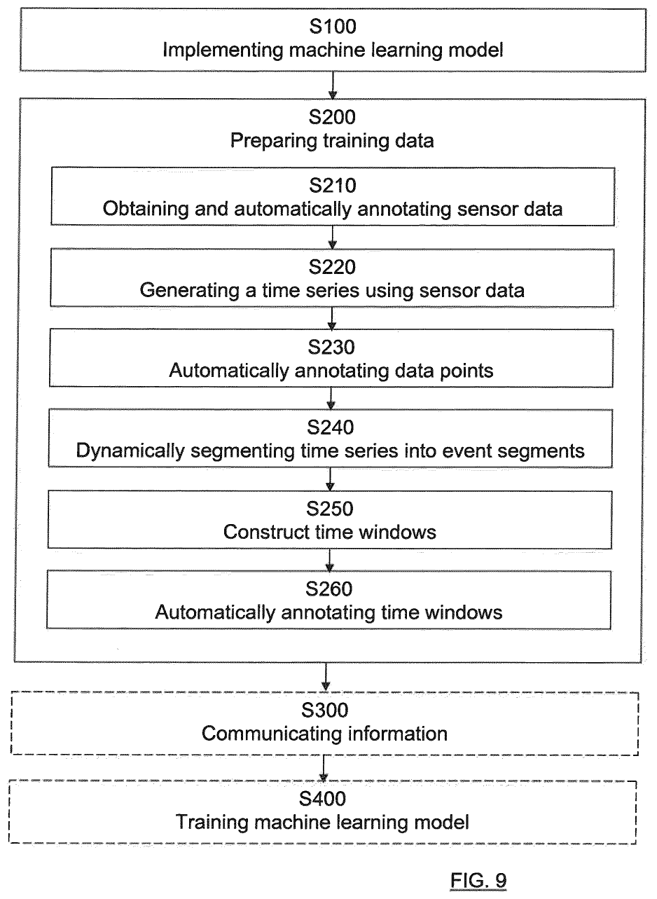

With reference to FIG. 9, the present disclosure relates to a computer-implemented method for training of a machine learning model in fall assessment comprising fall detection, for a fall assessment training environment; the method comprising implementing the machine learning model S100, and preparing S 200 training data.

Preparing training data S200 comprises obtaining and automatically annotating SS210 sensor data generated from sensors 2, 3, 6, 7 collecting data from subjects 1, and coupling values of each subject 1 to their specifically obtained, and annotated, sensor data, respectively, and using S220 the sensor data for generating a time series 400 that comprises data points.

Preparing data further comprises automatically annotating S230 the data points such that each data point is annotated reflecting the corresponding sensor data, respectively, and using S240 the annotated data points, dynamically segmenting said time series into at least event segments 401 associated with fall events and event segments 402, 403 that are not associated with fall events.

Preparing data also comprises using S250 the event segments 401 to construct time windows 404a-404f along the time series 400 such that the time series 400 is discretized, each time window 404a-404f comprising a plurality of time steps tₐ, t_{b}, t_{c} t_{d}, tₑ, and automatically annotating S260 the constructed time windows 404a-404f, where the automatic annotation of the time windows 404a-404f comprises information that identifies if the data points associated with the time steps tₐ, t_{b}, t_{c} t_{d}, tₑ in each time window 404a-404f belong to a fall event or to a non-fall event.

This allows more accurate automatic identification of fall segments 401 in a fall session using available information from the fallers/subjects and/or type of falls. This leads to more accurate annotation quality of time windows since the quality of the time window annotation is dependent on the quality of segmentation annotation.

According to some aspects, the automatic annotation of the time windows 404a-404f comprises
information that identifies the position of the time-steps belonging to the fall segment in each time window 404a-404f, and
information regarding an assigned weight to each time window 404a-404f, where the assigned weight has been determined in dependence of said position.

These weights improve the quality of the machine-learned model, constituting a way to inform the training algorithm that it is more important to detect a fall as soon as it starts.

According to some aspects, with reference to FIG. 9, the method further comprises communicating S300 information comprising the prepared training data to the machine learning model and training S400 the machine learning model using the training data comprising the prepared training data in fall assessment.

According to some aspects, the obtained, and annotated, sensor data comprise sensor data generated during doings of the trainer subjects, said doings comprising activities daily living (ADLs) including real fall events, and/or simulated falls.

This means that the sensor data can be generated in a controlled environment, during controlled circumstances. Uncontrolled environments are also conceivable. Simulated fall and physical activity data may come from virtual software based simulations. Both real and simulated falls can thus be considered, both for a walking user 1 and a user 1 riding a bike or a motor bike 8.

The present disclosure enables automatic annotation of the time windows as the fall and non-fall time segments are estimated in a whole session of real and/or simulated falls. This information is then used to automatically annotate time windows/samples which are then used to train the ML model. By assigning weights, it is possible to guide the ML model training on which sample(s) to put more focus on during the training/learning process.

The present disclosure also enables accurate automatic identification of fall segments in a fall session using available information from the fallers/subjects and/or type of falls among other info. This leads to more accurate annotation quality of time windows since the quality of the time window annotation is dependent on the quality of segmentation annotation.

According to some aspects, the data is collected i.e. obtained, to train the fall detection computer programs, i.e. to train the machine learning model, under a variety of designed experiments involving trainer subjects 1 performing variety of activities of daily living and performing various type of falls etc. using the pre-defined protocol, i.e. performing said doings in accordance with the set protocols.

According to some aspects, the computer-implemented method according to the present disclosure, as described herein, is disclosed, wherein the sensors 2, 3, 6, 7 comprise at least one of motion sensors, 3D sensors, accelerometers, gyroscopes and/or cameras. This means than many types of sensors can be used.

According to some aspects, the computer-implemented method according to the present disclosure, as described herein, is disclosed, wherein the trainer subjects 1 are provided with the sensors 2, 3, 6, 7, for example, being wearable sensors, e.g. comprising motion sensors, 3D sensors, accelerometers and/or gyroscopes.

Once the data are collected, i.e. obtained, from for example experiments, the data need to be pre-processed which involves various stages including data quality checks, cleaning, scaling of data (normalization). However, the most important facets of data processing involve preparing the data in a form which can be fed to machine learning computer program, i.e. communicated to the machine learning model, for training. This requires at least two main steps namely data segmentation, i.e. dynamic segmentations wherein time series is dynamically segmented into event segments, and time windowing.

For each time series data file we do the following, see “A single fall data file with time-series sensor data” in FIG. 3. We find 300, for example, the magnitude of triaxial acceleration at each time step based on the sensor readings in the time-series data. Based on the triaxial-acceleration we find 310 the peak (max value) to identify the time-index to with the start of (fall) event 401. This will be used as pivot point for constructing the dynamic time segment according to the steps 320 and 330.

FIG. 3, comprising input according to the steps 300-350, and output, illustrates a schematic presentation of a fall data processing and annotation System, in accordance with the present disclosure:
Input: A single fall data file with time-series sensor data.
Step 300: Compute the magnitude of sensor reading at each time step (using such as triaxial acceleration).
Step 310: Find the time-index with the “peak of magnitude” in time steps, this provides a “fall reference point” (pivot point) to construct a fall segment around.
Step 320: Construct a “fall-event” segment around the identified peak with certain computed duration using fallseg_duration( ) function which may decide the length of segment based on the empirical studies or computed from the fall experiments data representing the length of fall event per experiment.
Step 330: Data, for example experiment data, are segmented based on event of interest (i.e., a fall)

Note that use of triaxial-acceleration is only one example. We could have used other suitable measures, in accordance with the present disclosure, such as, for example, measures comprising magnitude of triaxial rotation speed (from gyroscope) and even a combination of these. The present disclosure is not limited to motion sensors so other types of sensors/camera devices can also be used to find the fall reference point.

A main intention is to find a pivot time point/s and/or marking step/s and annotate accordingly for dynamic segmentation of input time-series data. Once this pivot time point is identified as well as the segment duration, we can do the dynamic segmentation on the input time series data.

The dynamic segmentation on the input time series data generates time-segmented data. Note that time segments 104, 402, 403, i.e. fall time segments 401 (of event of interest) , i.e. event segments, will start before the identified peak (t0) and end at time t2 after the identified peak (t1). In other words, duration of the time segment mentioned earlier will be equal to t2-t0. Dynamic segment generation concept, i.e. the dynamic segmentations, in accordance with the present disclosure is illustrated in FIG. 4. In FIG. 4 identified event time-index relates to e.g. find the time-index with the “peak of magnitude” in time-steps, In FIG. 4 “Computed Fall Segment length” relates to “Construct a ”fall-event“ segment around the identified peek with certain computed duration using fallseg_duration( ) function” and “Experiment data is segmented based on event of interest (i.e., a fall)”.

Moreover, the dynamic segmentation of input time-series data may, in aspects of the disclosure, also easily be used to identify more granular pre-fall (i.e. (t0) to (t1) and post-fall segments (i.e. (t1) to (t2) instead of just one fall segment (comprising both pre and post fall) if desired.

Further referring to FIG. 3, comprising input, Steps 300-350, and output, wherein Steps 340, 350 and Output:
Step 340: With reference also to FIG. 4-FIG. 6, extract sliding time windows 404a-404f from the data with a certain window overlap size oₛ and window size wₛ. Window size wₛ amd “window overlap size oₛ relate to “Extract time windows from the data with a certain slide length & window size”, step 340 in FIG. 3.

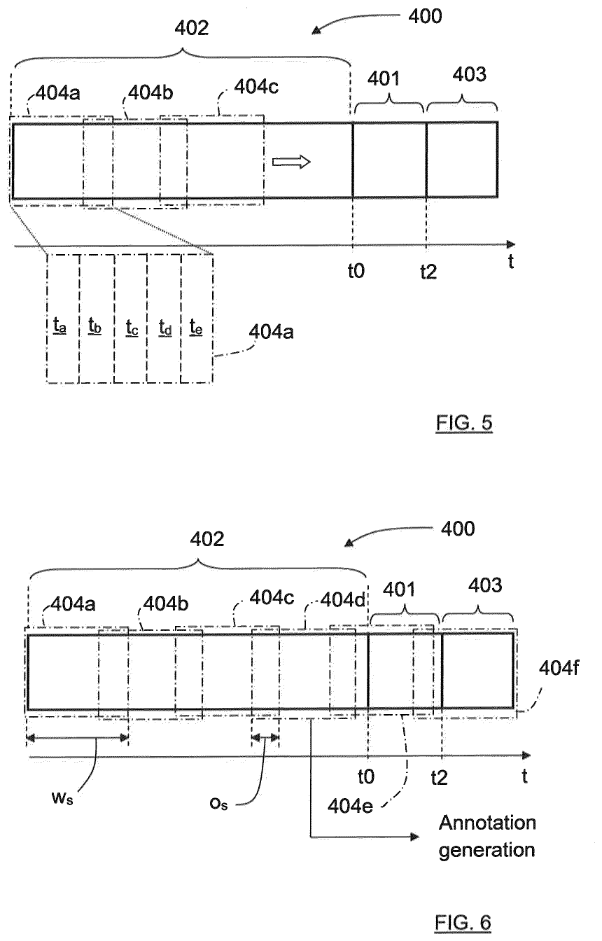

Regarding forming a time window shows a limited view of the time-series 400, in other words the time series data 400. For example, a time window of length 5 seconds means that whole time window can accommodate a 5 seconds of data at a time. In the example in FIG. 5, a time window can accommodate five time steps tₐ, t_{b}, t_{c}, t_{d}, tₑ.

Time windows may or may not have overlap. In the example in FIG. 5 and FIG. 6, there are overlapping time windows 404a-404f. The degree of overlap, the window overlap size oₛ depends on the slide-size specified. Lower the slide-size-the higher the window overlap size oₛ. As an example, as illustrated in FIG. 4 and FIG. 5, if say in a time window that has a window size wₛ of 5 seconds we have a slide-size of 4 seconds, the next created time window from data will have an overlap with the current window of one second of the old data and 4 seconds of new data at the front. In other words, two adjacent time windows 404a, 404b share a common time, an overlap size oₛ, of one second.

For a stronger overlap is could be that if say in a time window that has a window size wₛ of 5 seconds we have a slide-size of 1 second, the next created time window from data will have a strong overlap with the current time window of four second of the old data and 1 second of new data at the front.

The time windows are for example formed by having one time window with the specified window size wₛ and slide-size which moves/slides along the time axis t. Then all the time windows 404a-404f are formed by this procedure of sliding as indicated with an arrow in FIG. 5.

Forming, extracting, constructing or generating time windows, are to be considered as equivalents in this context.

Step 350: Now Generate an Annotation for Each Time Window Using a certain “policy” function, and

Output: Annotated data samples from data file, for example an experiment file.

Annotation generation concept for time windows, i.e. annotation of the constructed time windows, in accordance with the present disclosure is illustrated in FIG. 6 “Annotation of time windows”. This is because after defining, i.e. constructing, time windows there is the need to annotate each of the time windows i.e., annotate (data samples in the context of machine learning (ML)) with suitable annotation (that identifies if the data sample belong to, for example, a fall or a non-fall event) so that a fall detection computer program, i.e. a fall detection machine learning model, can learn from this annotated data.

One of the way to identify the annotation for each time window is to identify the time segment to which most of the time steps in that time window belong to. For example, if the majority of time steps belong to the fall segment then we annotate that time window with the fall and otherwise we annotate that time window with the no-fall. See FIG. 3 and Step 340: Extract sliding time windows from the data with a certain window overlap size oₛ and window size wₛ.

Aspects, in accordance with the present disclosure, may comprise also utilizing of a threshold-based scheme in the computer-implemented method for training of the machine learning model in fall assessment, as described herein, wherein the utilizing of the threshold-based scheme may be used as an enhancement on top of a disclosure as described herein. The utilizing of the threshold-based scheme may mean that a time window may only be annotated as fall time window if the number of time steps belonging to fall segment in that time window are above a certain threshold (e.g., 20%, 30%). This is true even if the time steps, which belong to the fall segment, are not in majority. This will in practice allows more suitable annotation for time windows, and/or for data samples, so as to ease the learning process of fall detection computer program, i.e. the training of the machine learning model in fall assessment, as described herein, to achieve a better fall detection performance.

Aspects, in accordance with the present disclosure, may comprise also utilizing of a threshold-based scheme in the computer-implemented method for training of the machine learning model in fall assessment, as described herein.

Further, in aspects, in accordance with the present disclosure, an event or an event segment, for example, a fall or a fall segment, may also belong to a “certain position” in the time window (e.g., within last 25%, last 50% of the time window), i.e. optionally in addition to utilizing of a threshold-based scheme, and the time windows, and/or for data samples, are thus then further annotated accordingly.

The computer-implemented method for training of the machine learning model in fall assessment, as described herein, comprises the preparation of training data wherein each trainer subject performs said doings in accordance with set protocols, and wherein the preparation of training data comprises obtaining, and automatic annotation, of sensor data, and coupling values of each trainer subject to their specifically obtained, and annotated, sensor data, respectively.

Said doings, in accordance with set protocols, comprise the activities of ADLs, such as physical activities, and the simulated falls.

According to some aspects, the computer-implemented method according to the present disclosure, as described herein, is disclosed, wherein the preparation of training data further comprises setting fall threshold values for sensor data and assignment of fall event segments if relevant sensor data are more than said fall threshold values.

According to some aspects, the computer-implemented method according to the present disclosure, as described herein, is disclosed, wherein the preparation of training data further comprises using a sliding time window method to resample coupled sensor data and identifying the position of an individual coupled sensor data segment in a time window.

According to some aspects, the computer-implemented method according to the present disclosure, as described herein, is disclosed, wherein the preparation of training data further comprises using a sliding time window method to resample coupled sensor data and identifying the position of the sensor data, belonging to an event segment, e.g. a fall segment, in a certain time window, and annotate the sensor data with respect to the position in the time window.

It is hereby possible, in accordance with the present disclosure, to use the sliding time window method and to perform annotation of time windows, based on the fact that time steps, i.e. sensor data with annotated positions, belonging to a fall segment lie in the tail part of the time window, as well as, to achieve sample weighting.

Furthermore, in aspects, in accordance with the present disclosure, the position in the time window of an event or an event segment, for example, of a fall or a fall segment, can also be used to assign sample weights to be utilized during training process, e.g., higher weight assigned to time windows/samples where the time steps belonging to the fall segment lie within the last 25% or “tail” of time window etc., i.e. during the computer-implemented method for training of the machine learning model in fall assessment, as described herein. This means that the later in a time window samples belonging to a fall segment are spotted, the higher are the assigned weights.

Using the assigned sample weights and utilizing during the computer-implemented method for training of the machine learning model in fall assessment, as described herein, may achieve the effect that clues to the fall detection computer program, i.e. the machine learning model, may be provided, e.g. clues that time steps that belong to fall segment and being in later positions in the time window, are more important to detect a fall. In other words, encouraging the fall detection computer program, i.e. the machine learning model in fall assessment, as described herein, to detect a fall as soon as possible to provide a maximum time for any suitable actuation, and/or any suitable preventive measure, to enable an optimized protection of the subject, i.e. a user, if a fall accident do happen.

In essence this means that both
a computer program, in accordance with the present disclosure, comprising computer readable instructions for applying the computer-implemented method for training of the machine learning model in fall assessment, as described herein, and
a computer program, in accordance with the present disclosure, comprising computer readable instructions for applying the preparation of training data, as described herein,
   will enable the preparation of the time series data from wearable sensors with suitable annotation in a “fully automated way”, i.e. completely automatic way, and without need for any manual time consuming, costly and error-prone human annotation effort. In this manner, afterwards, with the fully automated annotation the machine learning computer program, i.e. the machine learning model, as described herein, can be trained directly on the output of this annotation generation computer program, i.e. the computer program for applying the preparation of training data, as described herein, or the computer program for applying the computer-implemented method for training of the machine learning model, as described herein.

The present disclosure also relates to a system for training of a machine learning model in fall assessment, and in communication of information, wherein the information comprises information from the fall assessment, wherein the fall assessment comprises fall detection, and, optionally, fall characterization and/or computation of fall risk probability (FRP).

The system comprises a machine learning model, trainer subjects 1, sensors 2, 3, 6, 7 collecting data from the trainer subjects 1, means for obtaining data, means for processing data and means for communication of information. Te system utilizes the computer program, and/or the computer readable medium, both for applying the computer-implemented method for training of a machine learning model in fall assessment, and in communication of information from the fall assessment, and as described herein. It is to be appreciated that for all embodiments disclosed herein, FIG. 8 discloses a general representation of a computer program 810 comprising computer readable instructions 820 on a computer readable medium 830.

According to some aspects, the present disclosure also relates a system for training of a machine learning model in fall assessment, and in communication of information, wherein the information comprises information from the fall assessment, according to the present disclosure, as described herein, is disclosed, wherein the system comprises one, or more, devices, as described herein.

Further, the present disclosure does also relate to a computer-implemented method for fall assessment, and for communication of information from the fall assessment, for a fall assessment environment, wherein the fall assessment comprises fall detection, and, optionally, fall characterization and/or computation of fall risk probability (FRP).

The fall assessment environment comprises a machine learning model, comprising the trained machine learning model being trained in accordance with the computer-implemented method for training of a machine learning model in fall assessment, as described herein, and/or being trained in accordance with a computer-implemented method comprising the preparation of training data, as described herein, a user, sensors collecting data from the user, means for obtaining data, means for processing data, and means for communication of information.

The computer-implemented method comprises obtaining, and annotating, user sensor data generated from sensors collecting data from a user, wherein the user has a user profile, and the computer-implemented method further comprises obtaining values of the user profile properties, coupling to the user sensor data, and processing the coupled user sensor data by means of the machine learning model comprising the trained machine learning model, and/or being trained.

The computer-implemented method comprises the fall assessment and the communication of information from the fall assessment, wherein the fall assessment comprises fall detection, and, optionally, fall characterization and/or computation of fall risk probability (FRP).

The present disclosure also relates to a computer program 810 comprising computer readable instructions 820 for applying the computer-implemented method for fall assessment, and for communication of information from the fall assessment, as described herein.

The present disclosure does also relate to a computer readable medium 830 comprising the computer program 810 comprising computer readable instructions 820 for applying the computer-implemented method for fall assessment, and for communication of information from the fall assessment, as described herein.

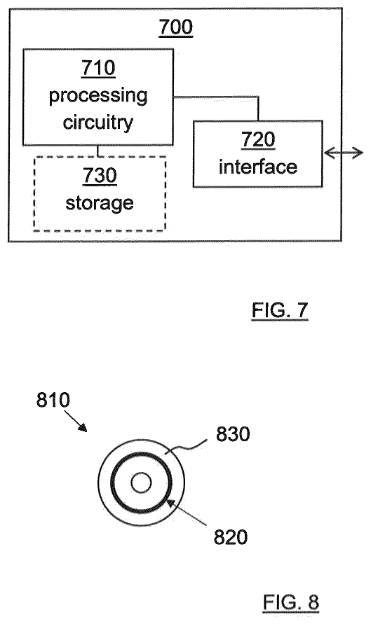

Further, with reference to FIG. 7, the present disclosure also relates to a control unit arrangement 700, for fall assessment, adapted to control at least: enablement of the computer-implemented method for fall assessment, wherein the computer-implemented method for fall assessment is as described herein, and/or the implementing of the machine learning model, comprising the trained machine learning model, as described herein.

FIG. 7 schematically illustrates, in terms of a number of functional units, the components of the control unit 700 according to an embodiment.

Processing circuitry 710 is provided using any combination of one or more of a suitable central processing unit (CPU), multiprocessor, microcontroller, digital signal processor (DSP), dedicated hardware accelerator, etc., capable of executing software instructions stored in a computer program product, e.g. in the form of a storage medium 730. The processing circuitry 710 may further be provided as at least one application specific integrated circuit (ASIC), or field programmable gate array (FPGA).

Particularly, the processing circuitry 710 is configured to cause the control unit 700 to perform a set of operations, or steps. These operations, or steps, were discussed above in connection to the various radar transceivers and methods. For example, the storage medium 730 may store the set of operations, and the processing circuitry 710 may be configured to retrieve the set of operations from the storage medium 730 to cause the control unit 700 to perform the set of operations. The set of operations may be provided as a set of executable instructions. Thus, the processing circuitry 710 is thereby arranged to execute methods and operations as herein disclosed.

The storage medium 730 may also comprise persistent storage, which, for example, can be any single one or combination of magnetic memory, optical memory, solid state memory or even remotely mounted memory.

The control unit 700 may further comprise a communications interface 720 for communications with at least one other unit. As such, the communications interface 720 may comprise one or more transmitters and receivers, comprising analogue and digital components and a suitable number of ports for wired or wireless communication.

The processing circuitry 710 is adapted to control the general operation of the control unit 700 e.g. by sending data and control signals to the external unit and the storage medium 730, by receiving data and reports from the external unit, and by retrieving data and instructions from the storage medium 730. Other components, as well as the related functionality, of the control unit 700 are omitted in order not to obscure the concepts presented herein.

As mentioned previously, FIG. 8 shows a computer program product 810 comprising computer executable instructions 820 arranged on a computer readable medium 830 to execute any of the methods disclosed herein.

According to some aspects, the present disclosure also relates to a device for fall assessment, for communication of information, wherein the information comprises information from the fall assessment, and for enabling the computer-implemented method for fall assessment, wherein the computer-implemented method for fall assessment is as described herein; wherein the fall assessment comprises fall detection, and, optionally, fall characterization and/or computation of fall risk probability (FRP); wherein the device comprises a machine learning model, sensors collecting data from users, means for obtaining data, means for processing data and means for communication of information; wherein the device comprises the computer program, and/or the computer readable medium, both, as described herein, and for applying the computer-implemented method for fall assessment, and for communication of information, wherein the information comprises information from the fall assessment, as described herein.

The fall assessment comprises fall detection.

In some aspects, in accordance with the disclosure, as described herein, the fall assessment may comprise fall detection and further also fall characterization and/or computation of fall risk probability (FRP).

According to some aspects, the device for fall assessment according to the present disclosure, as described herein, is disclosed, wherein the device is wearable by a user 1 and comprises sensor/s 2, 3, 6, 7 comprising accelerometer/s and/or gyroscope/s.

The present disclosure also relates to a system for fall assessment, for communication of information, wherein the information comprises information from the fall assessment, and for enabling the computer-implemented method for fall assessment, wherein the computer-implemented method for fall assessment is as described herein; wherein the fall assessment comprises fall detection, and, optionally, fall characterization and/or computation of fall risk probability (FRP).

The system comprises a machine learning model, a user, sensors collecting data from the user, means for obtaining data, means for processing data and means for communication of information; wherein the system comprises the computer program 810 comprising computer readable instructions 820 for applying the computer-implemented method for fall assessment, and for communication of information.

The information comprises information from the fall assessment, as described herein, and/or the computer readable medium 830 comprising the computer program 810 comprising computer readable instructions 820 for applying the computer-implemented method for fall assessment, and for communication of information, wherein the information comprises information from the fall assessment, as described herein.

According to some aspects, a system for fall assessment, and for communication of information, wherein the information comprises information from the fall assessment, according to the present disclosure, as described herein, is disclosed. The system comprises one, or more, devices for fall assessment, and for communication of information, wherein the information comprises information from the fall assessment, as described herein.

The computer-implemented method for training of the machine learning model in fall assessment, as described herein, comprises that the preparation comprises that said time series comprises annotated data points, wherein each data point is annotated reflecting the corresponding sensor data, respectively, and wherein said time series comprises dynamic segmentations wherein said time series is dynamically segmented into event segments.

The preparation of the training data further comprises that said time series comprises annotated data points, wherein each data point is annotated reflecting the corresponding sensor data, respectively. Said time series comprises dynamic segmentations wherein said time series is dynamically segmented into event segments.

Further, the computer-implemented method for training of the machine learning model in fall assessment, as described herein, further comprises that the method comprises that information comprising the prepared training data are communicated to the machine learning model and that the machine learning model is trained by means of the training data comprising the prepared training data in fall assessment.

Furthermore, the computer-implemented method for training of the machine learning model in fall assessment, as described herein, further comprises that the method comprises that information comprising the prepared training data are communicated to the machine learning model and that the machine learning model is trained, and is developed, both by means of the training data comprising the prepared training data, in/for fall assessment. The event segments are used to construct the time windows.

The constructed time windows are annotated, for example automatically annotated.

In accordance with the present disclosure, and as already described herein, the computer-implemented method for training of the machine learning model in fall assessment, as described herein, further comprises that the method comprises that

Information comprising the prepared training data are communicated to the machine learning model and that the machine learning model is trained by means of the training data comprising the prepared training data in fall assessment.

Further, in accordance with the present disclosure, and as also already described herein, the computer-implemented method for training of the machine learning model in fall assessment, as described herein, further comprises that the method comprises that information comprising the prepared training data are communicated to the machine learning model and that the machine learning model is trained, and is developed, both by means of the training data comprising the prepared training data, in/for fall assessment.

The machine learning model is trained by means of the training data, wherein the training data comprises the prepared training data.

The prepared training data comprises the constructed time windows, wherein the time windows are constructed based on sensor data, the generated time series and the dynamic segmentations. Each of the time windows represents one data sample and has sensor data at multiple time steps and associated annotation. This annotated data is then used to formulate and train a ML model, here a supervised ML model, to detect falls as early possible.

A supervised ML model utilizes annotated data, wherein the annotated data consists of input data and an agreed output. In, for example, one way for the purpose to formulate and train such a supervised ML model, a ML problem can be framed as a binary classification ML problem where a trained ML model, which is trained on the annotated data, can output a prediction whether a certain time window belongs to fall or a no-fall event. Further, the ML problem can, alternatively, also easily be formulated in alternative ways, for example, being formulated to a multi-class classification problem where the ML model can detect a pre-fall, fall and a post-fall event. Other variants of ML problem formulation are also possible.

One core advantage achieved by the computer-implemented method for training of the machine learning model in fall assessment, as described herein, and in accordance with the present disclosure, is that the method can take in not annotated raw sensor data and pre-process it and then annotate it to get it prepared for the supervised ML to train a data-driven supervised ML model. The machine learning model in fall assessment, in accordance with the present disclosure, here the data-driven supervised ML model, can, in the present computer-implemented method for training of the machine learning model in fall assessment, then be used for accurate fall detection in an early phase to do the suitable actuation/s and/or the suitable preventive measure/s. This is, in accordance with the present computer-implemented method for training of the machine learning model in fall assessment, done in completely automated way eliminating the need for any manual human effort and time.

Furthermore, the approach, in accordance with the present computer-implemented method for training of the machine learning model in fall assessment, is flexible enough to assign annotations in a fine-grained way based on not only on the threshold of time steps in the time window belonging to a fall segment, or not, but also to assign annotations based on the positioning of the time steps within a time window. Furthermore, to assign the annotations based on the positioning of the time steps within a time window, can also be used to assign sample weights.

Both of these ways to assign annotations will help the ML training process to train a ML model to achieve, not only high fall detection accuracy, but also which to detect a fall as soon as possible even before the actual fall happens. Accordingly, the present computer-implemented method for training of a machine learning model in fall assessment, as described herein, will, thus, also enable a ML model, in accordance with present disclosure, where there will be enough time available for any suitable actuation, and/or any suitable preventive measure, for example, for execution of any preventive measures such as a warning signal and protective measures such as inflation of one or more protection airbags 4, 5; 9 as illustrated in FIG. 1 and FIG. 2. As shown in FIG. 2, for a person or user 1 riding a motor bike 8 or similar, sensors 6, 7, control units 700 and/or protection airbags 9 can all be comprised in a protection garment such as a protection vest 10.

According to some aspects, the computer-implemented method according to the present disclosure, as described herein, is disclosed, wherein the preparation of training data further comprises selecting a specific type, or types, of sensor data, e.g. type, or types, of sensor data, in relation to an event of interest, for example, a fall event, and identifying corresponding annotated data points in the time series.

According to some aspects, the preparation of training data according to the present disclosure, as described herein, is disclosed, wherein the computer-implemented method further comprises utilization of a majority voting scheme for determining said corresponding sensor data to each annotated data point and for determining said dynamic segmentations into event segments.

The end objective for annotations is to prepare data for training using fall detection ML algorithm, i.e. fall detection ML computer program. This means to annotate time windows (aka data sample) extracted from time-series. The segmentation process is not necessary to extract/create time windows themselves but its necessary step to prepare for annotation of these time windows.

According to some aspects, the computer-implemented method for training of the machine learning model in fall assessment, as described herein, is disclosed, wherein profile properties of the trainer subject profiles comprise profile properties, such as, height, weight and/or Body Mass Index (BMI), and wherein the values of the profile properties enable correlation of trainer subject profiles to corresponding user profiles and more dynamic segmentation.

The values of these profile properties enable correlation of trainer subject profiles to corresponding user profiles. These profile properties may also influence this time-to-impact and hence allow more accurate definition of length of time segments for each subject/person and fall scenario.

In some aspects, the computer-implemented method for training of the machine learning model in fall assessment, as described herein, further comprises that the values of the profile properties, of each trainer subject profile, are coupled to their specifically obtained, and annotated, sensor data, respectively. The profile properties of the trainer subject profiles comprise profile properties, such as, height, weight and/or Body Mass Index (BMI), wherein the values of the profile properties enable correlation of trainer subject profiles to corresponding user profiles.

In particular the profile properties, as described herein, can help to improve dynamic segmentation process such as the duration of dynamic time segment may be tailored to each user profile which can results in higher quality data annotation based on individual user profiles.

Time-segment lengths in each time-series (generated from fall) will be different for each person and perhaps may also be customized based on the “type of fall” experienced by the person. As an example, a taller person will take a longer time to hit the ground (impact) after experiencing a fall hence time-segment generated for that person for that specific type of fall can be longer as compared to the similar fall event but for a person with a shorter height.

Similarly, BMI may also influence this time-to-impact and hence allow more accurate definition of length of time segments for each subject/person and fall scenario. Please note that it is proposed as an additional enhancement so one can still define a suitable “universal” segment length parameter applied to all subjects assuming such fine-grained subject profile information is not available or difficult to acquire.

The machine learning model is trained by means of the sensor data, the generated time series and the dynamic segmentations, to be adaptable to specific user profiles, time windowing using a certain annotation policy, and thereby to perform corresponding specific fall assessments, and to communicate information from said corresponding specific fall assessments.

Time-segmented data from the input time series can then be used to generate time windows, for example sliding time windows, of certain duration. To generate sliding time windows of certain duration, important parameters are sliding time window size, and slide length, which can be selected based on empirical studies or experimentation. These sliding windows will then form the actual data samples that will be input for the fall detection algorithm, i.e. computer program, training as well inference (predictions).

According to some aspects, the computer-implemented method according to the present disclosure, as described herein, is disclosed, wherein the training of the machine learning model comprises online training and/or offline training for example, one-time training.

Further, according to some aspects, the computer-implemented method according to the present disclosure, as described herein, is disclosed, wherein the training of the machine learning model comprises offline training, for example, one-time training, of the machine learning model.

Furthermore, the training of the machine learning model then utilizes the offline training for inferences and/or predictions. The utilization of the offline training is in contrast to the utilization of an online training where an ML model can be updated and/or re-trained periodically, or updating and/or re-training may be triggered when a sufficient change/shift in the distribution of input data is observed, wherein said change/shift is when compared to the training data which was used to train the ML model.

According to some aspects, the computer-implemented method according to the present disclosure, as described herein, is disclosed, wherein the preparation of training data, comprises offline preparation and/or online preparation, for example, the preparation of the machine learning model comprises offline preparation.

The present disclosure also relates to a computer program 810 comprising computer readable instructions 820 for applying the computer-implemented method for training of a machine learning model in fall assessment, and/or the preparation of training data, as described herein, and/or a computer readable medium 830 comprising said computer program 810.

Further, the present disclosure also relates to a computer program 810 comprising computer readable instructions 820 for applying the computer-implemented method for training of a machine learning model in fall assessment, as described herein, and/or a computer readable medium 830 comprising said computer program 810.

Furthermore, the present disclosure also relates to a computer program 810 comprising computer readable instructions 820 for applying the preparation of training data, as described herein, and/or a computer readable medium 830 comprising said computer program 810.

The present disclosure also relates to a computer program 810 comprising computer readable instructions 820 for the preparation of training data, as described herein, and/or a computer readable medium 830 comprising said computer program 810.

Further, the present disclosure also relates to a computer program 810 comprising computer readable instructions 820 for a machine learning model, as described herein, and/or a computer readable medium 830 comprising said computer program 810.

The present disclosure does also relate to a computer readable medium 830 comprising the computer program 810, as described herein.

Further, the present disclosure also relates to a control unit arrangement 700, for training of a machine learning model, adapted to control at least, the implementing the machine learning model, as described herein, and/or the preparation of training data, as described herein.

The present disclosure also relates to a device for training of a machine learning model in fall assessment, for communication of information, wherein the information comprises information from the fall assessment, and for enabling implementation of the machine learning model, wherein the machine learning model is as described herein; wherein the fall assessment comprises fall detection, and, optionally, fall characterization and/or computation of fall risk probability (FRP).

The device comprises a machine learning model, sensors collecting data from trainer subjects, means for obtaining data, means for processing data and means for communication of information; wherein the device comprises the computer program 810, and/or the computer readable medium 830, both, as described herein, and for applying the computer-implemented method for training of a machine learning model in fall assessment, and in communication of information, wherein the information comprises information from the fall assessment, and as described herein.

Further, the present disclosure also relates to a device for training of a machine learning model in fall assessment, for communication of information, wherein the information comprises information from the fall assessment, and for enabling implementation of the machine learning model. The machine learning model is as described herein; wherein the fall assessment comprises fall detection, and, optionally, fall characterization and/or computation of fall risk probability (FRP).

The device comprises a machine learning model, sensors collecting data from trainer subjects, means for obtaining data, means for processing data and means for communication of information; wherein the device comprises the computer program 810, and/or the computer readable medium 830, both, as described herein, for the preparation of training data, and as described herein.

The present disclosure also relates to a device for training of a machine learning model in fall assessment, for communication of information, wherein the information comprises information from the fall assessment, and for enabling implementation of the machine learning model, wherein the machine learning model is as described herein. The fall assessment comprises fall detection, and, optionally, fall characterization and/or computation of fall risk probability (FRP) ; the device comprises a machine learning model, sensors collecting data from trainer subjects, means for obtaining data, means for processing data and means for communication of information; wherein the device comprises the computer program 810, and/or the computer readable medium 830, both, as described herein, and for, and for enabling implementation of, the machine learning model, and as described herein.

According to some aspects, the device for training of a machine learning model in fall assessment, and in communication of information, wherein the information comprises information from the fall assessment, and for enabling implementation of the machine learning model, wherein the machine learning model is as described herein, according to the present disclosure, as described herein, is disclosed, wherein the device is wearable by a trainer subject 1 and comprises sensor/s 2, 3, 6, 7 comprising accelerometer/s and/or gyroscope/s.

According to some aspects, the device is at least partly in the form of a vest 10 or similar garment. The device can also be constituted by a control unit arrangement 700 and/or a bracelet or similar. In FIG. 1, a user 1 is shown hearing a sensor 2 that is comprised in a bracelet. Generally, the present disclosure relates to a 15 a piece of garment 10 comprising the control unit arrangement 700 as described herein, one or more sensors 2, 3, 6, 7 detecting data as described herein, and at least one airbag 4, 5, 9.

According to some aspects, the present disclosure relates to a computer-implemented method for training of a machine learning model in fall assessment, for a fall assessment training environment, wherein the fall assessment comprises fall detection. The fall assessment training environment comprises a machine learning model, trainer subjects, sensors collecting data from trainer subjects, means for obtaining data, means for processing data and means for communication of information.

The computer-implemented method comprises implementing the machine learning model and preparation of training data, wherein the machine learning model during its implementation continuously enables the preparation of training data. The preparation Of training data comprises obtaining, and annotating, sensor data generated from sensors collecting data from the trainer subjects, wherein the obtained, and annotated, sensor data comprise sensor data generated during doings of the trainer subjects, said doings comprising activities of daily living (ADLs) and simulated falls.

Each trainer subject performs said doings in accordance with set protocols, where the preparation of training data comprises obtaining, and automatic annotation, of sensor data, and coupling values of each trainer subject to their specifically obtained, and annotated, sensor data, respectively, and the coupled sensor data are then further processed and whereby a time series is generated, wherein said time series comprises annotated data points, wherein each data point is annotated reflecting the corresponding sensor data, respectively, and wherein said time series comprises dynamic segmentations wherein said time series is dynamically segmented into event segments, wherein the event segments are then used to construct time windows, and the constructed time windows are annotated.

The computer-implemented method comprises that information comprising the prepared training data are communicated to the machine learning model and the machine learning model is trained by means of the training data comprising the prepared training data in fall assessment.

According to some aspects, the present disclosure relates to a device for training of a machine learning model in fall assessment, for communication of information, for enabling implementation of the machine learning model according to any of claims 1-7, and for enabling the preparation of training data according to any of claims 1-7; wherein the fall assessment comprises fall detection; the device comprises a machine learning model, sensors collecting data from trainer subjects, means for obtaining data, means for processing data and means for communication of information; wherein the device comprises the computer program 810, and/or the computer readable medium as described herein.

According to some aspects, the present disclosure relates to a device for fall assessment, for communication of information, and for enabling the computer-implemented method for fall assessment according to claim 13; wherein the fall assessment comprises fall detection; wherein the device comprises a machine learning model, sensors collecting data from users, means for obtaining data, means for processing data and means for communication of information; wherein the device comprises a computer program 810, and/or a computer readable medium 830 as described herein.

According to some aspects, the present disclosure relates to a system for fall assessment, and for communication of information, and for enabling the computer-implemented method for fall assessment according to claim 13; wherein the fall assessment comprises fall detection; wherein the system comprises a machine learning model, a user, sensors collecting data from the user, means for obtaining data, means for processing data and means for communication of information; wherein the system comprises a computer program 810, and/or a computer readable medium 830 as described herein.

1. A computer-implemented method for training of a machine learning model in fall assessment comprising fall detection, for a fall assessment training environment; the method comprising
implementing the machine learning model, and
preparing training data,
where preparing-training data comprises
obtaining and automatically annotating ( sensor data generated from sensors collecting data from subject, and coupling values of each subject to their specifically obtained, and annotated, sensor data, respectively,
using the sensor data for generating a time series that comprises data points,
automatically annotating the data points such that each data point is annotated reflecting the corresponding sensor data, respectively,
using the annotated data points, dynamically segmenting said time series into at least event segments associated with fall events and event segments that are not associated with fall events,
using the event segments to construct time windows along the time series such that the time series is discretized, each time window comprising a plurality of time steps, and
automatically annotating the constructed time windows, where the automatic annotation of the time windows comprises information that identifies if the data points associated with the time steps in each time window belong to a fall event or to a non-fall event.

2. The computer-implemented method according to claim 1, wherein the automatic annotation of the time windows comprises
information that identifies the position of the time-steps belonging to the fall segment in each time window, and
information regarding an assigned weight to each time window, where the assigned weight has been determined in dependence of said position.

3. The computer-implemented method according to claim 1, further comprising
communicating information comprising the prepared training data to the machine learning model and
training the machine learning model using the training data comprising the prepared training data in fall assessment.

4. The computer-implemented method according to claim 1, wherein the obtained, and annotated, sensor data comprise sensor data generated during doings of the trainer subjects, said doings comprising activities of daily living (ADLs), including real fall events, and/or simulated falls.

5. The computer-implemented method according to claim 1, wherein the sensors comprise at least one of motion sensors, 3D sensors, accelerometers, gyroscopes and/or cameras.

6. The computer-implemented method according to claim 1, wherein the preparation of training data further comprises setting fall threshold values for sensor data and assignment of fall event segments if relevant sensor data are more than said fall threshold values.

7. The computer-implemented method according to claim 1, wherein the preparation of training data further comprises utilization of a majority voting scheme for determining said corresponding sensor data to each annotated data point and for determining said dynamic segmentations into event segments.

8. The computer-implemented method according to claim 1, wherein profile properties of the trainer subject profiles comprise profile properties, such as, height, weight and/or Body Mass Index (BMI), and wherein the values of the profile properties enable
correlation of trainer subject profiles to corresponding user profiles, and
more precise dynamic segmentation.

9. A computer program comprising computer readable instructions for applying the computer-implemented method, and/or the preparation of training data, according to claim 1, and/or a computer readable medium comprising said computer program.

10. A computer program comprising computer readable instructions for a machine learning model according to claim 1, and/or a computer readable medium comprising said computer program.

11. A control unit arrangement, for training of a machine learning model, adapted to control at least, the implementing the machine learning model according to claim 1, and/or the preparation of training data.

12. A system for training of a machine learning model in fall assessment, for communication of information, for enabling implementing the machine learning model according to claim 1, and for enabling the preparation of the training data
wherein the fall assessment comprises fall detection;
the system comprises a machine learning model, trainer subjects, sensors collecting data from the trainer subjects, means for obtaining data, means for processing data and means for communication of information;
wherein the system utilizes a computer program comprising computer readable instructions for applying the computer-implemented method, and/or the preparation of training data, and/or a computer readable medium comprising said computer program.

13. A computer-implemented method for fall assessment, and for communication of information from the fall assessment, for a fall assessment environment;
wherein the fall assessment comprises fall detection;
the fall assessment environment comprises a machine learning model, comprising the trained machine learning model being trained in accordance with the computer-implemented method, and/or being trained in accordance with a computer-implemented method comprising the preparation of training data, of claim 1, a user, sensors collecting data from the user, means for obtaining data, means for processing data and means for communication of information;
wherein the computer-implemented method comprises implementing the machine learning model comprising obtaining, and annotating, user sensor data generated from sensors collecting data from a user, wherein the user has a user profile, and the computer-implemented method further comprises obtaining values of the user profile properties, coupling to the user sensor data, and processing the coupled user sensor data by means of the machine learning model comprising the trained machine learning model, and/or being trained, and
wherein the computer-implemented method comprises the fall assessment and the communication of information from the fall assessment, wherein the fall assessment comprises fall detection.

14. A computer program comprising computer readable instructions for applying the computer-implemented method according to claim 13, and/or a computer readable medium comprising said computer program.

15. A control unit arrangement-for fall assessment, adapted to control at least, enablement of the computer-implemented method for fall assessment according to claim 13, and/or the implementing of the machine learning model, comprising the trained machine learning model.

16. A system for training of a machine learning model in fall assessment, for communication of information, for enabling implementing the machine learning model according to claim 1, and for enabling the preparation of training data;
wherein the fall assessment comprises fall detection;
the system comprises a machine learning model, trainer subjects, sensors collecting data from the trainer subjects, means for obtaining data, means for processing data and means for communication of information;
wherein the system utilizes a computer program comprising computer readable instructions for the machine learning model, and/or a computer readable medium comprising said computer program.
